(19) United States
(12) Patent Application Publication
(10) Pub. No.: US 2020/0211794 A1
(43) Pub. Date: Jul. 2, 2020

(54) NOISE REDUCTION STRUCTURE OF BUTTON ASSEMBLY

(71) Applicant: HON HAI PRECISION INDUSTRY CO., LTD., New Taipei (TW)

(72) Inventors: I-HSUN TSENG, New Taipei (TW); HAO-YUAN HUANG, New Taipei (TW)

(21) Appl. No.: 16/262,009

(22) Filed: Jan. 30, 2019

(30) Foreign Application Priority Data
Dec. 28, 2018 (CN) 201811626798.5

(51) Int. Cl. H01H 13/14; H01H 13/52; H01H 13/04

(52) U.S. Cl. CPC H01H 13/14; H01H 13/52; H01H 13/04; H01H 13/84; H01H 2221/062; H01H 2223/034; H01H 2233/07

(57) ABSTRACT

A noise reduction structure of a button assembly including a keycap, a trigger portion, a circuit board, and an elastic piece includes an extension portion, a buffer portion, and an abutting portion. The extension portion extends from the keycap toward the abutting portion. The buffer portion is mounted to at least one of the extension portion or the abutting portion and is located between the extension portion and the abutting portion. When the keycap is pressed, the extension portion is moved away from the abutting portion, the trigger portion presses the elastic piece to deform the elastic piece, and the elastic piece contacts the circuit board. When the keycap is released, a restoring force of the elastic piece drives the extension portion to move toward the abutting portion, and the buffer portion buffers contact between the abutting portion and the extension portion.

### FIELD

The subject matter herein generally relates to button assemblies, and more particularly to a button assembly having a noise reduction structure.

### BACKGROUND

Generally, keyboards of computers, laptops, and other electronic devices generate noise when keys of the keyboard are pressed. Such noise may disturb others in an office environment or in public spaces.

### BRIEF DESCRIPTION OF THE DRAWINGS

Implementations of the present disclosure will now be described, by way of embodiments, with reference to the attached figures.

FIG. 1 is an isometric view of an embodiment of an electronic device.

FIG. 2 is a cross-sectional diagram of a button assembly of the electronic device including a noise reduction structure according to a first embodiment.

FIG. 3 is an enlarged view of circled portion III in FIG. 2.

FIG. 4 is similar to FIG. 3, but showing the noise reduction structure according to a second embodiment.

FIG. 5 is similar to FIG. 3, but showing the noise reduction structure according to a third embodiment.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

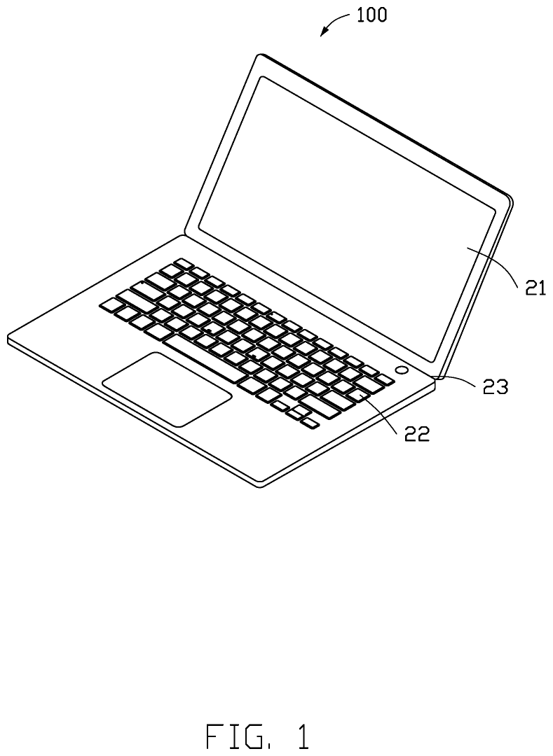

FIG. 1 shows an embodiment of an electronic device 100. The electronic device 100 can be a desktop computer, a notebook computer, or the like.

The electronic device 100 includes a display screen 21, a keyboard 22, and a connecting device 23. The display screen 21 and the keyboard 22 are coupled together by the connecting device 23.

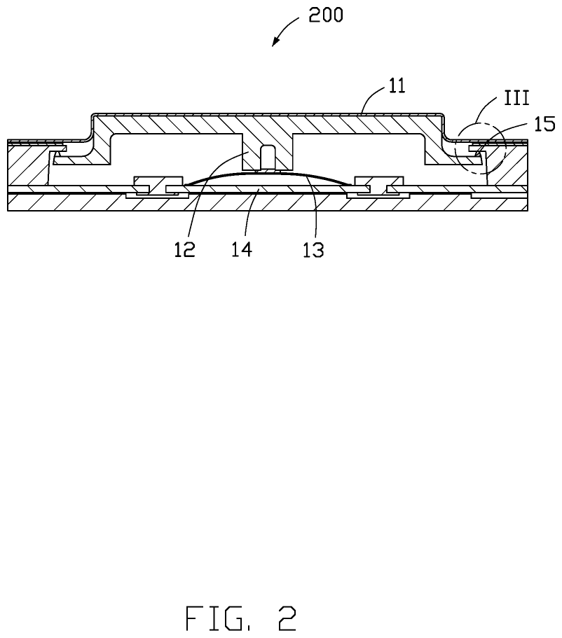

FIG. 2 shows an embodiment of a button assembly 200 of the electronic device 100. The button assembly 200 includes a noise reduction structure 15, a keycap 11, a trigger portion 12, an elastic piece 13, and a circuit board 14.

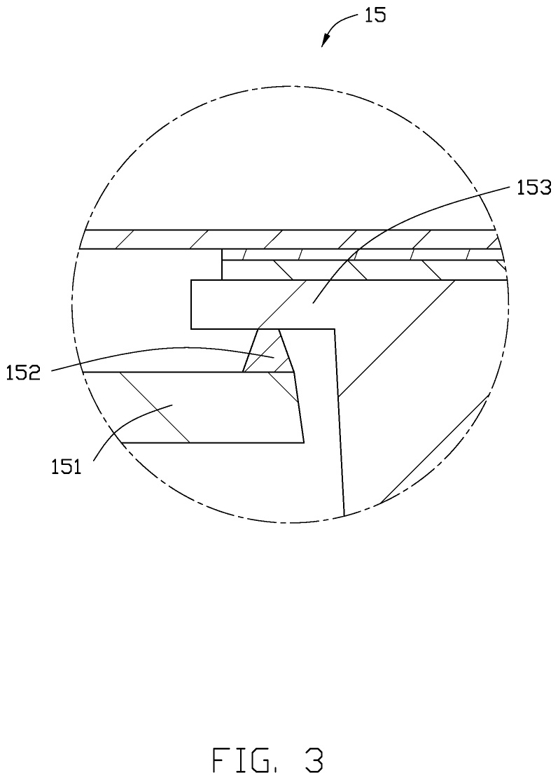

Referring to FIG. 3, the noise reduction structure 15 includes an extension portion 151, a buffer portion 152, and an abutting portion 153. The abutting portion 153 is located outside the keycap 11, and the extension portion 151 extends from the keycap 11 toward the abutting portion 153 to an underside of the abutting portion 153. The buffer portion 152 is mounted to at least one of the extension portion 151 and the abutting portion 153 and is located between the extension portion 151 and the abutting portion 153. The buffer portion 152 reduces noise generated when the extension portion 151 comes into contact with the abutting portion 153. When the keycap 11 is pressed, the extension portion 151 is moved away from the abutting portion 153, the trigger portion 12 presses the elastic piece 13 to elastically deform the elastic piece 13, and the elastic piece 13 contacts the circuit board 14. When the keycap 11 is released, a restoring force of the elastic piece 13 drives the extension portion 151 to move toward the abutting portion 153, and the buffer portion 152 buffers contact between the abutting portion 153 and the extension portion 151.

The buffer portion 152 is mounted to the extension portion 151 or the abutting portion 153 by an adhesive.

The buffer portion 152 is made of rubber, latex, styrofoam, foam, or EPE.

A cross-sectional shape of the buffer portion 152 may be triangular, round, quadrangular, semicircular, trapezoidal, or other shape. As shown in FIG. 3, a cross-sectional shape of the buffer portion 152 is trapezoidal.

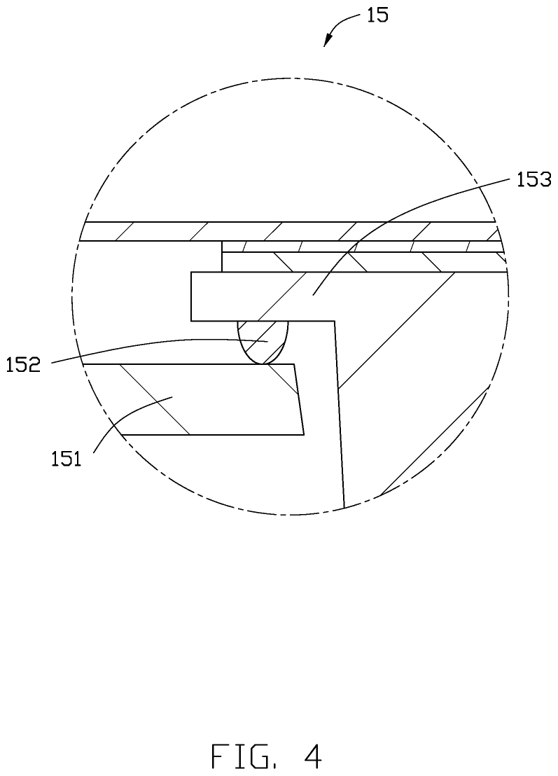

FIG. 4 shows a second embodiment of the noise reduction structure 15. As shown in FIG. 4, a cross-sectional shape of the buffer portion 152 is dome-shaped.

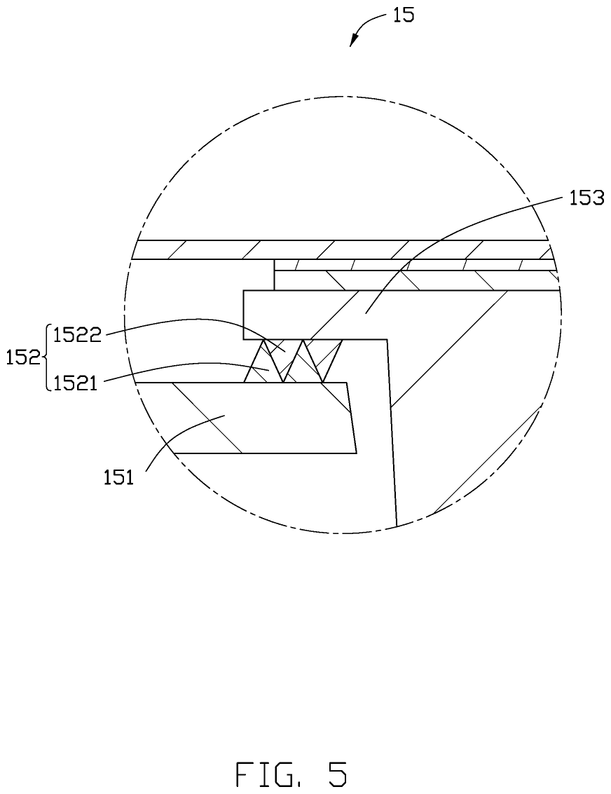

FIG. 5 shows a third embodiment of the noise reduction structure 15. As shown in FIG. 5, the buffer portion 152 includes at least one first buffer portion 1521 and at least one second buffer portion 1522. The first buffer portion 1521 is mounted to the extension portion 151, and the second buffer portion 1522 is mounted to the abutting portion 153.

The first buffer portion 1521 is mounted to the extension portion 151 by an adhesive, and the second buffer portion 1522 is mounted to the abutting portion 153 by an adhesive.

As shown in FIG. 5, a cross-sectional shape of the first buffer portion 1521 and of the second buffer portion 1522 is triangular, and there are two first buffer portion s1521 and two second buffer portions 1522 alternately arranged.

Since the cross-sectional shape of the buffer portion 152 is triangular, round, quadrangular, semicircular, trapezoidal, or other shape, a contact area between the extension portion 151 and the abutting portion 153 is reduced. Thus, the buffer portion 152 has a damping effect to reduce noise generated between the extension portion 151 and the abutting portion 153 when the elastic piece 13 restores the keycap after being pressed.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A noise reduction structure of a button assembly comprising a keycap, a trigger portion, a circuit board, and an elastic piece, the noise reduction structure comprising:
an extension portion;
a buffer portion; and
an abutting portion located at a periphery of the keycap; wherein:
the extension portion extends from the keycap to a lower side of the abutting portion;
the buffer portion is mounted to at least one of the extension portion and the abutting portion and is located between the extension portion and the abutting portion;
when the keycap is pressed, the extension portion is moved away from the abutting portion, the trigger portion presses the elastic piece to deform the elastic piece, and the elastic piece contacts the circuit board;
when the keycap is released, a restoring force of the elastic piece drives the extension portion to move toward the abutting portion, and the buffer portion buffers contact between the abutting portion and the extension portion
the buffer portion comprises at least one first buffer portion and at least one second buffer portion, wherein the first buffer portion is mounted to the extension portion, the second buffer portion is mounted to the abutting portion, and the first and the second buffer portions are between the extension portion and the abutting portion.

2. (canceled)

3. The noise reduction structure of claim 1, wherein a cross-sectional shape of the buffer portion is triangular, round, quadrangular, semicircular, or trapezoidal.

4. The noise reduction structure of claim 1, wherein the buffer portion is mounted to at least one of the extension portion and the abutting portion by an adhesive.

5. The noise reduction structure of claim 1, wherein the buffer portion is made of rubber, latex, styrofoam, foam, or EPE.

6. A button assembly comprising:
a noise reduction structure;
a keycap;
a trigger portion;
a circuit board; and
an elastic piece; wherein:
the noise reduction structure comprises an extension portion, a buffer portion, and an abutting portion located at a periphery of the keycap; wherein:
the extension portion extends from the keycap to a lower side of the abutting portion;
the buffer portion is mounted to at least one of the extension portion and the abutting portion and is located between the extension portion and the abutting portion;
when the keycap is pressed, the extension portion is moved away from the abutting portion, the trigger portion presses the elastic piece to deform the elastic piece, and the elastic piece contacts the circuit board;
when the keycap is released, a restoring force of the elastic piece drives the extension portion to move toward the abutting portion, and the buffer portion buffers contact between the abutting portion and the extension portion
the buffer portion comprises at least one first buffer portion and at least one second buffer portion, wherein the first buffer portion is mounted to the extension portion, the second buffer portion is mounted to the abutting portion, and the first and the second buffer portions are between the extension portion and the abutting portion.

7. (canceled)

8. The button assembly of claim 6, wherein a cross-sectional shape of the buffer portion is triangular, round, quadrangular, semicircular, or trapezoidal.

9. The button assembly of claim 6, wherein the buffer portion is mounted to at least one of the extension portion and the abutting portion by an adhesive.

10. The button assembly of claim 6, wherein the buffer portion is made of rubber, latex, styrofoam, foam, or EPE.

11. The button assembly of claim 6 comprising two noise reduction structures located at respective opposite sides of the keycap.

12. An electronic device comprising a button assembly comprising a noise reduction structure, a keycap, a trigger portion, a circuit board, and an elastic piece, the noise reduction structure comprising:
an extension portion;
a buffer portion; and
an abutting portion located at a periphery of the keycap; wherein:
the extension portion extends from the keycap to a lower side of the abutting portion;
the buffer portion is mounted to at least one of the extension portion and the abutting portion and is located between the extension portion and the abutting portion;
when the keycap is pressed, the extension portion is moved away from the abutting portion, the trigger portion presses the elastic piece to deform the elastic piece, and the elastic piece contacts the circuit board;
when the keycap is released, a restoring force of the elastic piece drives the extension portion to move toward the abutting portion, and the buffer portion buffers contact between the abutting portion and the extension portion;
the buffer portion comprises at least one first buffer portion and at least one second buffer portion, wherein the first buffer portion is mounted to the extension portion, the second buffer portion is mounted to the abutting portion, and the first and the second buffer portions are between the extension portion and the abutting portion.

13. (canceled)

14. The electronic device of claim 12, wherein a cross-sectional shape of the buffer portion is triangular, round, quadrangular, semicircular, or trapezoidal.

15. The electronic device of claim 12, wherein the buffer portion is mounted to at least one of the extension portion and the abutting portion by an adhesive.

16. The electronic device of claim 12, wherein the buffer portion is made of rubber, latex, styrofoam, foam, or EPE.

17. The electronic device of claim 12, wherein the button assembly comprises two noise reduction structures located at respective opposite sides of the keycap.
